(19) United States
(12) Patent Application Publication
(10) Pub. No.: US 2021/0334723 A1
(43) Pub. Date: Oct. 28, 2021

(54) INFORMATION PROCESSING APPARATUS, INFORMATION PROCESSING METHOD, AND RECORDING MEDIUM

(71) Applicant: TOYOTA JIDOSHA KABUSHIKI KAISHA, Toyota-shi (JP)

(72) Inventors: Shin SAKURADA, Toyota-shi (JP); Kazuya NISHIMURA, Toyota-shi (JP); Masaru ANDO, Seto-shi (JP); Toshinari HONDA, Anjo-shi (JP)

(73) Assignee: TOYOTA JIDOSHA KABUSHIKI KAISHA, Toyota-shi (JP)

(21) Appl. No.: 17/233,889

(22) Filed: Apr. 19, 2021

(30) Foreign Application Priority Data
Apr. 22, 2020 (JP) 2020-076158

(51) Int. Cl. G06Q 10/06; G07C 9/20; G06Q 30/06

(52) U.S. Cl. CPC G06Q 10/06314; G06Q 30/0645; G07C 9/20

(57) ABSTRACT

An information processing apparatus includes a controller that receives, from a terminal of a first user among a plurality of users including a user not belonging to a predetermined organization, a request for use of to a first vehicle associated with the predetermined organization for other than a business activity in the predetermined organization, and registers, in response to the request, a schedule for use of the first vehicle for other than the business activity. Moreover, a user terminal transmits, to a predetermined apparatus, the request for use of first vehicle associated with the predetermined organization for other than the business activity in the predetermined organization from the first user among a plurality of users including a user not belonging to the predetermined organization, and receives, from the predetermined apparatus, in response to the request, a schedule for use of the first vehicle for other than the business activity.

### CROSS REFERENCE TO THE RELATED APPLICATION

This application claims the benefit of Japanese Patent Application No. 2020-076158, filed on Apr. 22, 2020, which is hereby incorporated by reference herein in its entirety.

### BACKGROUND

### Technical Field

The present disclosure relates to an information processing apparatus, an information processing method, and a recording medium.

### Description of the Related Art

There is disclosed a company/employee car sharing system for enabling car-sharing between a company and an employee, according to which a company rents out a company vehicle to an employee for personal use (for example, Patent document 1).

[Patent document 1] Japanese Patent Laid-Open No. 2019-061575

An object of the present disclosure is to provide an information processing apparatus, an information processing method, and a recording medium that are capable of increasing a utilization rate of a company vehicle.

### SUMMARY

One aspect of the present disclosure is an information processing apparatus comprising a controller configured to:

receive, from a terminal of a first user among a plurality of users including a user not belonging to a predetermined organization, a request for use of a first vehicle associated with the predetermined organization for other than a business activity in the predetermined organization, and register, in response to the request, a schedule for use of the first vehicle for other than the business activity.

Another aspect of the present disclosure is an information processing method comprising:

receiving, from a terminal of a first user among a plurality of users including a user not belonging to a predetermined organization, a request for use of a first vehicle associated with the predetermined organization for other than a business activity in the predetermined organization, and

registering, in response to the request, a schedule for use of the first vehicle for other than the business activity.

Another aspect of the present disclosure is a non-transitory computer-readable recording medium recorded with a program for causing a computer to:

transmit, to a predetermined apparatus, a request for use of a first vehicle associated with a predetermined organization for other than a business activity in the predetermined organization from a first user among a plurality of users including a user not belonging to the predetermined organization, and

receive, from the predetermined apparatus, in response to the request, a schedule for use of the first vehicle for other than the business activity.

According to the present disclosure, a utilization rate of a company vehicle may be increased.

### BRIEF DESCRIPTION OF THE DRAWINGS

FIG. 1 is a diagram illustrating an example of a system configuration of a company-vehicle rental system according to a first embodiment;

FIG. 2 is an example of a hardware configuration of the center server, the company vehicle, and the user terminal;

FIG. 3 is a diagram illustrating an example of a functional configuration of the center server and the user terminal;

FIG. 4 is an example of a data structure of the vehicle information database;

FIG. 5 is an example of a data structure of the user information database:

FIG. 6 is an example of a data structure of the schedule information database;

FIG. 7 is an example of the rental request screen that is displayed on the user terminal;

FIG. 8 is an example of a flowchart of a search condition input process by the user terminal;

FIG. 9 is an example of a flowchart of a reservation control process by the center server;

FIG. 10 is an example of a flowchart of a key information management process by the center server.

### DESCRIPTION OF THE EMBODIMENTS

An aspect of the present disclosure is an information processing apparatus that includes a controller. For example, the information processing apparatus is, but not limited to, a server. The controller receives, from a terminal of a first user among a plurality of users including a user not belonging to a predetermined organization, a request for use of a first vehicle associated with the predetermined organization for other than a business activity in the predetermined organization, and registers, in response to the request, a schedule for use of the first vehicle for other than the business activity. The controller is a processor such as a central processing unit (CPU), for example.

The predetermined organization is a company, a public office, a local authority, or the like, for example. The first vehicle that is associated with the predetermined organization is a vehicle that is owned by the predetermined organization, or a vehicle that the predetermined organization is leasing from another organization, for example. The first vehicle that is associated with the predetermined organization is a vehicle that is referred to as a company vehicle, a government vehicle, or a business vehicle, for example. Use of the first vehicle for other than business activity may include, in addition to a personal use of the vehicle, a preliminary or preparatory use that is a part of the activity in the organization but that is different from the original purpose of using the vehicle, such as simply moving the vehicle between hubs of the organization (relocation of the vehicle).

In one aspect of the present disclosure, by renting out the first vehicle associated with the predetermined organization to be used for other than the business activity regardless of whether a user belongs to the organization or not, a utilization rate of the first vehicle may be increased. For example, by collecting a rental fee from a user for use for other than the business activity, a cost related to the first vehicle may be supplemented. The cost related to the first vehicle may be a parking fee, a fuel fee, a lease fee, a maintenance fee or the like, for example.

In one aspect of the present disclosure, the controller may further be configured to transmit, to the terminal of the first user, key information that is used for unlocking and starting of the first vehicle. For example, the first vehicle is provided with an apparatus that authenticates the terminal of the first user by the key information, and that enables unlocking of the door and starting of the engine or the motor. When the key information of the first vehicle is transmitted to the terminal of the first user, the terminal of the first user transmits the key information to the first vehicle together with an authentication request by predetermined near-field wireless communication, and is enabled to use the first vehicle by successful authentication.

Furthermore, in this case, the controller may be further adapted to invalidate the key information transmitted to the terminal of the first user in a case where the schedule for use of the first vehicle for other than the business activity is ended. This prevents the first vehicle from being used for other than the schedule or from being stolen.

In one aspect of the present disclosure, the controller may receive, together with the request for use of the first vehicle for other than the business activity in the predetermined organization, condition information about a departure spot, a return spot and a rental period desired by the first user. For example, at least one of the departure spot and the return spot may be a location that is associated with the predetermined organization. A location that is associated with the predetermined organization is, but not limited to, company premises, a shop, or a parking lot on the company premises or of the shop, for example. Moreover, the departure spot and the return spot may be different spots or a same spot.

Furthermore, a settable period for the rental period may be limited to within a first period that is shorter than a settable period for use for the business activity. For example, the first period may be the day of use, today or tomorrow. Accordingly, in relation to use of the first vehicle associated with the predetermined organization, use for the business activity is prioritized, and the business activity may be prevented from being obstructed by use of the first vehicle for other than the business activity.

One aspect of the present disclosure is a non-transitory computer-readable medium recorded with a program. The program is a program for causing a computer to transmit, to a predetermined apparatus, a request for use of a first vehicle associated with a predetermined organization for other than a business activity in the predetermined organization from a first user among a plurality of users including a user not belonging to the predetermined organization, and receive, from the predetermined apparatus, in response to the request, a schedule for use of the first vehicle for other than the business activity. The program is an application program that is installed in a terminal of a user, for example. The predetermined apparatus as a transmission destination of the request is a server, for example. According to one aspect of the present disclosure, the first vehicle associated with the predetermined organization may be used for other than the business activity regardless of whether the user belongs to the organization or not.

In the following, an embodiment of the present disclosure will be described with reference to the drawings. The configuration of the embodiment described below is an example, and the present disclosure is not limited to the configuration of the embodiment.

### First Embodiment

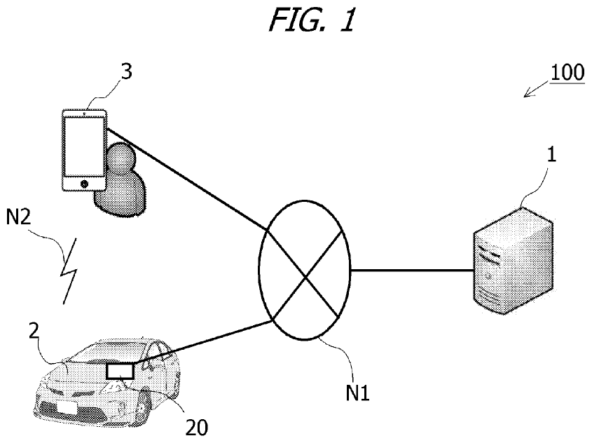

FIG. 1 is a diagram illustrating an example of a system configuration of a company-vehicle rental system 100 according to a first embodiment. The company-vehicle rental system 100 is a system for renting out a company vehicle of one company to employees and general users to be used for other than business activities. The company vehicle is a vehicle that is owned or leased by a predetermined company, for example. A general user is a user who does not belong to the company that is associated with the company vehicle, for example. Additionally, an organization that can use the company-vehicle rental system 100 is not limited to a company, and may be an organization such as a public office or a local authority.

The company-vehicle rental system 100 includes a center server 1, a company vehicle 2, and a user terminal 3. FIG. 1 illustrates one company vehicle 2 and one user terminal 3 for the sake of convenience, but a plurality of company vehicles 2 and a plurality of user terminals 3 are actually included. A vehicle control apparatus 20 that controls locking/unlocking of a door of the company vehicle 2 and starting of an engine is mounted in the company vehicle 2. The user terminal 3 is a terminal of an employee of the company using the company-vehicle rental system 100 or a general user, and a client application program for enjoying a service of the company-vehicle rental system 100 is installed therein. The center server 1 is an example of “information processing apparatus”. The company vehicle 2 is an example of “first vehicle”. A user of the user terminal 3 is an example of “first user”. The user terminal 3 is an example of “terminal of the first user”.

The center server 1, the vehicle control apparatus 20, and the user terminal 3 are connected to a network N1 that is a public network such as the Internet. The vehicle control apparatus 20 and the user terminal 3 are each capable of communicating with the center server 1. The vehicle control apparatus 20 and the user terminal 3 are capable of communicating with each other over a near-field wireless communication network N2.

A user transmits a rental request for the company vehicle from the user terminal 3 to the center server 1 through the client application program. User identification information, purpose of use, and search conditions including a rental period, a departure spot and a return spot are also transmitted together with the rental request. Purpose of use may be a business activity or a personal use, for example. The rental request for the company vehicle 2 in a case where the purpose of use is a personal use is an example of “request for use for other than a business activity in the predetermined organization”. The rental request for the company vehicle 2 from a general user is also an example of “request for use for other than a business activity in the predetermined organization”.

When the rental request is received from the user terminal 3, the center server 1 extracts the company vehicles 2 that match the search conditions, and transmits information about the extracted company vehicles 2 to the user terminal 3. The user terminal 3 displays the information about the company vehicles 2 matching the search conditions, and transmits, to the center server 1, a reservation request for the company vehicle 2 that is selected by a user operation. The center server 1 receives the reservation request from the user terminal 3, registers a schedule for the selected company vehicle 2, and fixes the reservation.

When a time that is a predetermined time before a start time of the rental period for the company vehicle 2 is reached, the center server 1 generates key information of the company vehicle 2, and transmits the key information to the user terminal 3 and the company vehicle 2. The user transmits the key information from the user terminal 3 to the vehicle control apparatus 20 over the near-field wireless communication network N2, and when authentication is performed by the vehicle control apparatus 20, unlocking of the door and starting of the engine are enabled for the company vehicle 2.

According to the first embodiment, by renting out the company vehicle 2 for uses other than the business activity, the company vehicle 2 is used also when the company vehicle 2 is not being used for the business activity, and the utilization rate of the company vehicle 2 may be increased. Furthermore, by collecting a rental fee for uses other than the business activity, a maintenance fee and the like of the company vehicle 2 may be supplemented.

Additionally, in the first embodiment, the rental period is limited in the case where the purpose of use is personal use. This is to prioritize use of the company vehicle 2 for the business activity to uses for other than the business activity. For example, in the case where the purpose of use is personal use, reservation may be allowed on the day of use. In contrast, in the case where the purpose of use is the business activity, reservation may be allowed one month in advance, for example. This is to prevent occurrence of a situation where the company vehicle 2 becomes unavailable for the business activity due to being rented out for personal use.

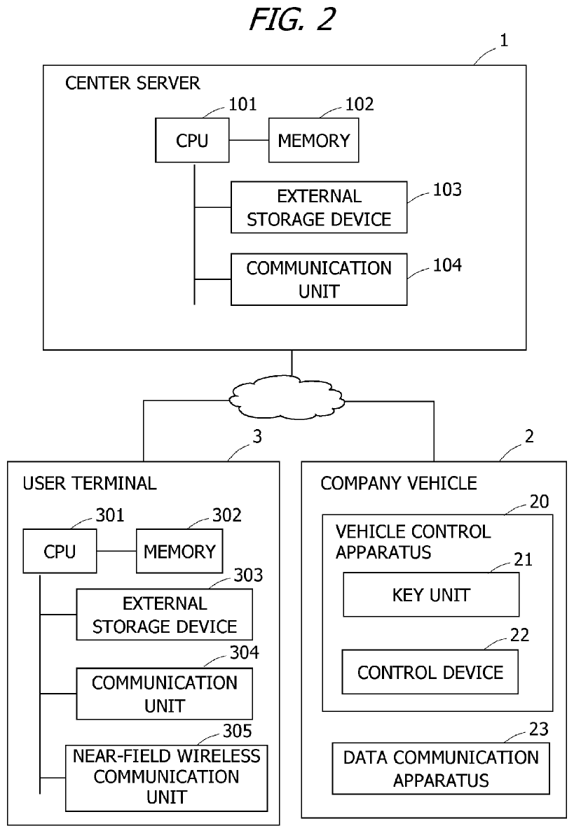

FIG. 2 is an example of a hardware configuration of the center server 1, the company vehicle 2, and the user terminal 3. The center server 1 includes, as the hardware configuration, a CPU 101, a memory 102, an external storage device 103, and a communication unit 104. The memory 102 and the external storage device 103 are each a computer-readable recording medium. The center server 1 is an example of “information processing apparatus” and “predetermined apparatus”.

The external storage device 103 stores various programs, and data to be used by the CPU 101 at the time of execution of each program. For example, the external storage device 103 is an erasable programmable ROM (EPROM) or a hard disk drive. The programs to be held in the external storage device 103 include an operating system (OS), a control program of the company-vehicle rental system 100, and various other application programs.

The memory 102 is a main memory that provides, to the CPU 101, a storage area for loading programs stored in the external storage device 103 and a work area, and that is used as a buffer. The memory 102 includes semiconductor memories such as a read only memory (ROM) and a random access memory (RAM), for example.

The CPU 101 performs various processes by loading the OS and various application programs held in the external storage device 103 into the memory 102 and executing the same. The number of CPUs 101 is not limited to one, and a plurality of CPUs may be provided. The CPU 101 is an example of “controller”.

The communication unit 104 is a wired network card such as a local area network (LAN) or a dedicated line, and the communication unit 104 connects to a public network such as the Internet over an access network such as the LAN.

The user terminal 3 is a smartphone, a tablet terminal, a wearable terminal, or a laptop personal computer (PC), for example. The user terminal 3 includes, as the hardware configuration, a CPU 301, a memory 302, an external storage device 303, a communication unit 304, and a near-field wireless communication unit 305, for example. The CPU 301, the memory 302, and the external storage device 303 are the same as the CPU 101, the memory 102, and the external storage device 103. An OS, the client application program of the company-vehicle rental system 100, and various other application programs are stored in the external storage device 303 of the user terminal 3, for example.

The communication unit 304 is an interface through which information is input/output from a network. The communication unit 304 is an interface that connects to a wireless network. For example, the communication unit 304 performs 5th generation (5G), long term evolution (LTE) or 3rd generation (3G) mobile communication, or communication according to a wireless communication standard such as WiFi.

The near-field wireless communication unit 305 performs so-called wireless communication over a short distance by a predetermined near-field wireless communication method. A short distance is a distance at which communication between inside and outside the vehicle may be performed, for example. The near-field wireless communication unit 305 uses Bluetooth (registered trademark) Low Energy standard, Near Field Communication (NFC), Ultra Wideband (UWB), or a communication standard such as WiFi (registered trademark), for example. In the first embodiment, the key information is transmitted to the company vehicle 2 through the near-field wireless communication unit 305.

In addition to the hardware configuration described above, the user terminal 3 includes an input device such as a touch panel display or a keyboard, an audio output device such as a speaker, and an audio input device such as a microphone.

The company vehicle 2 includes the vehicle control apparatus 20 and a data communication apparatus 23. The data communication apparatus 23 is an apparatus that communicates with the center server 1. For example, the data communication apparatus 23 includes a CPU, a memory, an external storage device, and a communication unit. The communication unit of the data communication apparatus 23 performs 5G, LTE or 3G mobile communication or communication according to a wireless communication standard such as WiFi, for example.

The vehicle control apparatus 20 includes a key unit 21 and a control device 22. The key unit 21 is a device that is arranged at a predetermined position in a vehicle interior of the company vehicle 2 (such as inside a glove compartment). The key unit 21 includes a function of authenticating the user terminal 3, and a function of transmitting, based on the authentication result, a command signal to the control device 22 by predetermined radio waves. The key unit 21 performs near-field wireless communication with the user terminal 3 according to a same near-field wireless communication standard as that of the user terminal 3. The key unit 21 receives an authentication request together with the key information from the user terminal 3 by near-field wireless communication, performs comparison against key information that is held in advance, and authenticates the user terminal 3 in the case of match. A control command is received together with the key information. After authenticating the user terminal 3, the key unit 21 transmits a command signal based on the control command from the user terminal 3 to the control device 22. The control command from the user terminal 3 may be for unlocking or locking of the door, starting of the engine, or the like, for example.

The control device 22 performs, in relation to the company vehicle 2, locking and unlocking of the door of the company vehicle 2 and starting of the engine, for example, by transmitting/receiving predetermined radio waves to/from the key unit 21. Additionally, the company vehicle 2 may be an electric vehicle, and in this case, the control device 22 performs control of starting an electric motor that is a drive source.

Additionally, the hardware configurations of the center server 1, the company vehicle 2, and the user terminal 3 are not limited to those illustrated in FIG. 2.

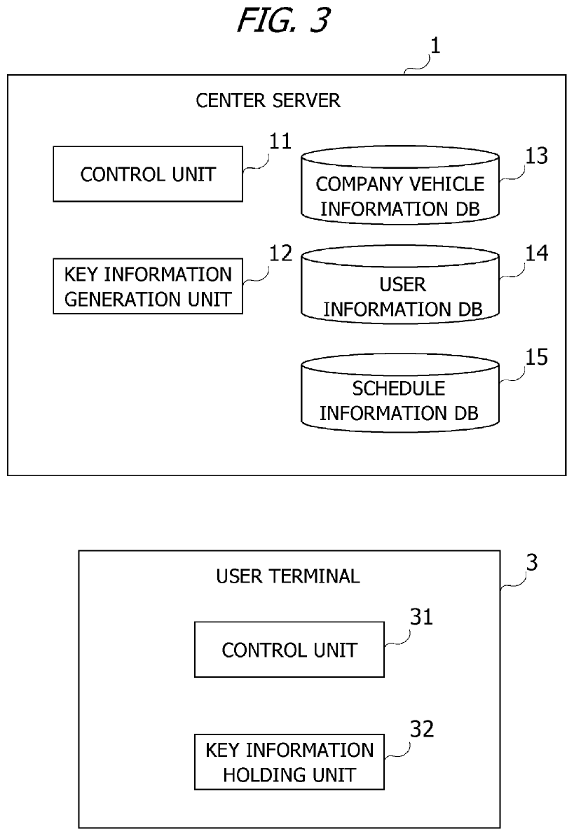

FIG. 3 is a diagram illustrating an example of a functional configuration of the center server 1 and the user terminal 3. The center server 1 includes, as functional components, a control unit 11, a key information generation unit 12, a company vehicle information database (DB) 13, a user information DB 14, and a schedule information DB 15. These functional elements are implemented by the CPU 101 of the center server 1 executing control programs of the company-vehicle rental system 100, for example.

The control unit 11 controls rental of the company vehicle 2. Specifically, the control unit 11 receives the rental request for the company vehicle from the user terminal 3. The user identification information, the purpose of use (if the user is an employee), and the search conditions are also received from the user terminal 3 together with the rental request. The search conditions include the rental period, the departure spot, and the return spot, for example. The purpose of use may be business activity or personal use, for example.

After receiving the rental request, the control unit 11 refers to the vehicle information DB 13 and the schedule information DB 15 described later, and extracts one or more company vehicles 2 that satisfy the search conditions. For example, one or more company vehicle 2 that satisfy the search conditions are one or more vehicles for which a schedule is not set in the rental period included in the search conditions and that are located at the departure spot included in the search conditions at a time of start of the rental period included in the search conditions. The control unit 11 transmits one or more pieces of information about the one or more company vehicles 2 that satisfy the search conditions to the user terminal 3 that is the transmission source of the rental request. One piece of information about the company vehicle 2 transmitted to the user terminal 3 is information about a body type of the vehicle and options that are mounted, for example.

The control unit 11 receives a reservation request from the user terminal 3. Rental information including information indicating the company vehicle 2 that is a reservation target, the rental period, the departure spot and the return spot is also received together with the reservation request. Additionally, in the case where the user is an employee, information indicating whether the purpose of use is a business activity or a personal use is also received with the reservation request. The control unit 11 registers the received rental information in the schedule information DB 15, and a rental reservation for the company vehicle 2 is thereby fixed. Then, the control unit 11 notifies the user terminal 3 that the rental reservation for the company vehicle 2 is fixed. Information about the schedule for which the reservation is fixed is also transmitted to the user terminal 3 together with the notification that the reservation is fixed. Information about the schedule for which the reservation is fixed includes the rental period, the departure spot, the return spot, and information about the company vehicle 2 that is the rental target, for example. Information about the company vehicle 2 that is the rental target includes information presented on a license plate and information about the body type of the vehicle, for example.

Next, in relation to rental of the company vehicle 2, the control unit 11 manages the key information of the company vehicle 2. Specifically, when a time that is a predetermined time before the time of start of rental of the company vehicle 2 is reached, the control unit 11 generates the key information, and transmits the key information to the user terminal 3 and the company vehicle 2. Although dependent of the method of a locking/unlocking system of the company vehicle 2 that is adopted, notification of the key information to the user terminal 3 is performed through push notification, an email or a short message service (SMS). In relation to the company vehicle 2, the key information is transmitted to the data communication apparatus 23.

Furthermore, in the case where rental of the company vehicle 2 is ended, the control unit 11 invalidates the key information of the company vehicle 2 dispatched before start of the rental. End of rental of the company vehicle 2 is detected based on end of the rental period or reception of a notice of end of rental from the user terminal 3, for example. The key information of the company vehicle 2 is invalidated by newly generating the key information of the company vehicle 2 and notifying the company vehicle 2 of the same to update the key information held in the company vehicle 2, or by notifying the company vehicle 2 of invalidation of the key information so that use of the key information is stopped or the key information is deleted, for example. Furthermore, in one process of invalidating the key information of the company vehicle 2, the user terminal 3 may be instructed to stop using the key information or to delete the key information.

The key information generation unit 12 generates the key information of the company vehicle 2 according to an instruction from the control unit 11. For example, the key information is, but not limited to, a character string generated by combining letters and numbers. A generation method of the key information is not limited to a specific method. The key information generation unit 12 outputs the generated key information to the control unit 11.

The vehicle information DB 13, the user information DB 14, and the schedule information DB 15 are created in a predetermined area in the external storage device 103 of the center server 1. The vehicle information DB 13 stores information about the company vehicle 2. The user information DB 14 stores information about a user registered in the company-vehicle rental system 100. The schedule information DB 15 stores information about the schedule of rental of the company vehicle 2. Details of information pieces stored in the databases will be given later.

Next, the user terminal 3 includes, as functional components, a control unit 31 and a key information holding unit 32. These functional elements are functions that are implemented by the CPU 301 of the user terminal 3 executing the client application program of the company-vehicle rental system 100.

The control unit 31 displays a rental request screen on a display of the user terminal 3, and receives input of a rental request and the search conditions through the rental request screen. The rental request screen is a screen where the search conditions are set. For example, user registration is performed at the time of first execution of the client application program. At this time, user identification information is assigned by the center server 1 and is stored also in the user terminal 3. Furthermore, at the time of user registration, user type, name, address, sex and the like are also set by the user as user information, and are saved in a client application and transmitted to the center server 1. The user type may be an employee or a general user, for example. At the time of second and later execution, the rental request screen is displayed as a top screen, for example. The user identification information, the user type and the like are stored in a predetermined storage area in the external storage device 303 of the user terminal 3.

In the case where the user type is a general user, the control unit 31 limits a settable range of the rental period on the rental request screen to within a predetermined period. For example, in the case of a general user, the control unit 31 limits the rental period to within the day of use. Additionally, in the case where the user type is an employee, the control unit 31 changes the settable range of the rental period according to the purpose of use. In the case where the purpose of use is business activity, the control unit 31 does not impose any limits on the settable range of the rental period. In the case where the purpose of use is personal use, the control unit 31 limits the settable range of the rental period to within a predetermined period.

The control unit 31 transmits the rental request and the search conditions input through the rental request screen to the center server 1. Additionally, the user identification information is also transmitted together with the rental request.

As a response to the rental request, the control unit 31 receives information about one or more company vehicles 2 that match the search conditions from the center server 1. The control unit 31 displays the information about the one or more company vehicles 2 on the display. When user operations regarding selection of a vehicle and the reservation request are input, the control unit 31 transmits the reservation request and the rental information to the center server 1. For example, the rental information includes information indicating the company vehicle 2 that is the reservation target, and information including the rental period, the departure spot and the return spot. Additionally, in the case where the user is an employee, the rental information also includes information indicating business activity or personal use as the purpose of use.

In the case where a response to the reservation request is received from the center server 1, the control unit 31 displays contents of the response on the display. For example, the response to the reservation request may indicate that the reservation is fixed or that the reservation failed to be fixed. In the case where the reservation is fixed, information about the schedule for which the reservation is fixed is also received from the center server 1.

The control unit 31 receives, from the center server 1, key information of the company vehicle 2 for which reservation of rental is fixed. The control unit 31 stores the key information in the key information holding unit 32. Furthermore, the control unit 31 enables access to an operation screen for the company vehicle 2 during a scheduled period of rental of the company vehicle 2. For example, in a case where an instruction for unlocking or locking of the company vehicle 2, starting of the engine or the like is input on the operation screen for the company vehicle 2, the control unit 31 issues the key information via the near-field wireless communication unit 305 by near-field wireless communication. For example, when the operation screen for the company vehicle 2 is closed, transmission of the key information is stopped.

Additionally, the functional configurations of the center server 1 and the user terminal 3 illustrated in FIG. 3 are merely examples, and are not limiting.

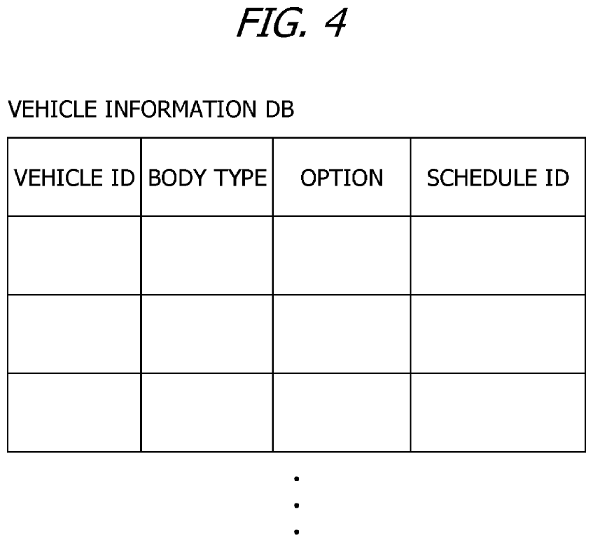

FIG. 4 is an example of a data structure of the vehicle information DB 13. A record in the vehicle information DB 13 includes the following fields: vehicle ID, body type, option, and schedule ID. Identification information of the company vehicle 2 is stored in the field “vehicle ID”. Information indicating the body type of the company vehicle 2 is stored in the field “body type”. The body type of the company vehicle 2 may be a sedan or a wagon, for example. Information indicating options that are mounted in the company vehicle 2 is stored in the field “option”.

Identification information of a schedule that is set for the company vehicle 2 and that is not yet carried out is stored in the field “schedule ID”. Values are set in advance in the fields “vehicle ID”, “body type” and “option”. The value in the field “schedule ID” is updated by the control unit 11 when a schedule is set for the company vehicle 2 and when the schedule of the company vehicle 2 is completed, for example. Additionally, the data structure of the vehicle information DB 13 is not limited to the one illustrated in FIG. 4.

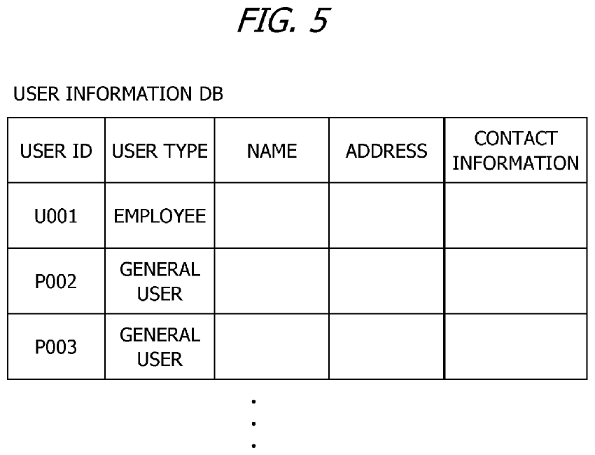

FIG. 5 is an example of a data structure of the user information DB 14. A record in the user information DB 14 includes the following fields: user ID, user type, name, address, and contact information. User identification information is stored in the field “user ID”. Information indicating the user type is stored in the field “user type”. The user type may be an employee or a general user, for example. The name of the user is stored in the field “name”. The address of the user is stored in the field “address”. Information about the telephone number, the email address or an address for push notification of the user is stored in the field “contact information”, for example.

The record in the user information DB 14 is registered by the control unit 11 when user registration is performed via the user terminal 3. Additionally, the data structure of the user information DB 14 is not limited to the one illustrated in FIG. 5.

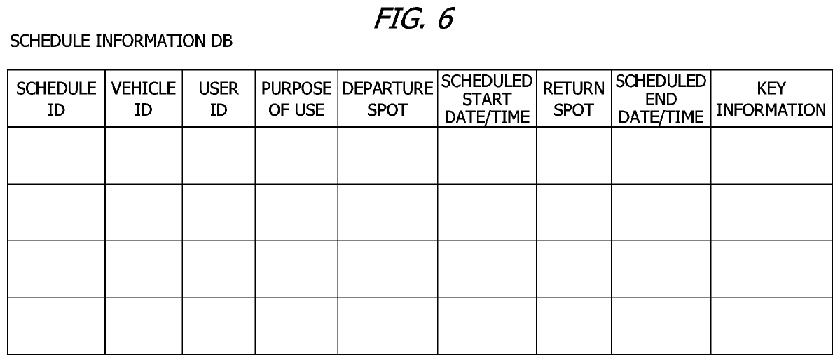

FIG. 6 is an example of a data structure of the schedule information DB 15. A record in the schedule information DB 15 includes the following fields: schedule ID, vehicle ID, user ID, purpose of use, departure spot, scheduled start date/time, return spot, scheduled end date/time, and key information.

Identification information of a schedule is stored in the field “schedule ID”. Identification information of a company vehicle 2 to which the schedule is assigned is stored in the field “vehicle ID”. User identification information of the user who made reservation for the schedule is stored in the field “user ID”.

Information indicating the type of the purpose of use is stored in the field “purpose of use”. The purpose of use may be business activity or personal use, for example. In the case where the user indicated in the field “user ID” is an employee, for example, a value is stored in the field “purpose of use”. In the case where the user indicated in the field “user ID” is a general use, the field “purpose of use” is empty or Null is stored therein.

Information pieces indicating the departure spot and the return spot, respectively, are stored in the corresponding fields “departure spot” and “return spot”. As the departure spot or the return spot, a hub of the company using the company-vehicle rental system 100 and other than the hub of the company using the company-vehicle rental system 100, such as a parking lot, may be cited, for example. The hub of the company using the company-vehicle rental system 100 may be a head office, a branch office, a shop, a sales office or the like, for example. Information indicating the departure spot or the return spot is a code, for example.

Information pieces indicating the scheduled start date/time and the scheduled end date/time of the rental period, respectively, are stored in the corresponding fields “scheduled start date/time” and “scheduled end date/time”. Key information that is issued for the schedule is stored in the field “key information”.

The record in the schedule information DB 15 is created by the control unit 11 when a reservation request for rental of the company vehicle 2 is received, for example. The identification information of the schedule in the field “schedule ID” is assigned by the control unit 11. The identification information of the company vehicle 2 in the field “vehicle ID” is the identification information of the company vehicle 2 selected by the user. The user identification information in the field “user ID” is the user identification information of the user who made the reservation. Information pieces included in the rental information that is received together with the reservation request are stored in the fields “purpose of use”, “departure spot”, “scheduled start date/time”, “return spot”, and “scheduled end date/time”.

As the value in the field “key information”, key information generated by the key information generation unit 12 is stored by the control unit 11. Additionally, the data structure of the schedule information DB 15 is not limited to the one illustrated in FIG. 6.

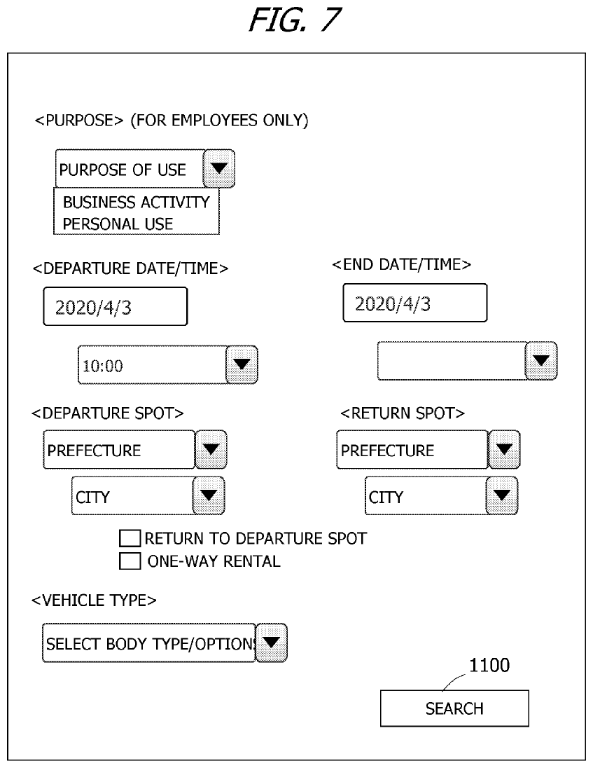

FIG. 7 is an example of the rental request screen that is displayed on the user terminal 3. The rental request screen is a screen where search conditions are set and a rental request is input. The rental request screen illustrated in FIG. 7 include sections for setting the purpose of use, a departure date/time, an end date/time, the departure spot, the return spot, and the type of the vehicle. A selected item selected by the user in each selection section is included in the search conditions to be transmitted to the center server 1 together with the rental request.

The section for setting the purpose is displayed when the user is an employee, for example. The section for setting the purpose is not displayed when the user is a general user. Additionally, the type of the user is set when the client application program is first executed, for example.

In relation to the sections for setting the departure date/time and the end date/time, if the user is a general user or if the user is an employee and the purpose of use is personal use, only selection of dates in a predetermined period of time is automatically enabled, and setting of other dates is disabled, for example. This enables use for business activity to be prioritized when a reservation is made for the company vehicle 2. In the case of use for business activity, the departure date/time and the end date/time in a longer period of time may be selected than in the case of use for other than business activity.

In the section for setting the departure spot, buttons for selecting return to the departure spot or one-way rental are set. For example, when the button for return to the departure spot is selected, same information as the departure spot is automatically input in the section for setting the return spot.

The user operation for the rental request is input by selection of a search button 1100. The control unit 11 thus transmits the rental request to the center server 1 with the information set on the rental request screen as the search conditions. Additionally, the content of the rental request screen is not limited to the one illustrated in FIG. 7.

<Flow of Processes>

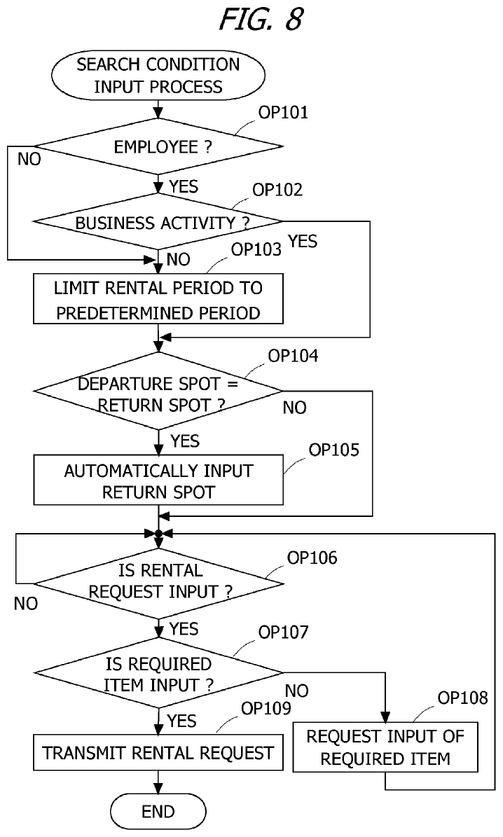

FIG. 8 is an example of a flowchart of a search condition input process by the user terminal 3. The example illustrated in FIG. 8 is a process that assumes the rental request screen illustrated in FIG. 7. The process illustrated in FIG. 8 is started by the user terminal 3 at time same time as activation of the client application of the company-vehicle rental system 100 and display of the rental request screen. The performer of the process illustrated in FIG. 8 is the CPU 301 of the user terminal 3, but a functional element is described to be the performer for the sake of convenience.

In OP101, the control unit 31 determines whether the user type is an employee or not. In the case where the user type is an employee (OP101: YES), the process proceeds to OP102. In the case where the user type is not an employee, or in other words, in the case where the user type is a general user (OP101: NO), the process proceeds to OP103. Additionally, the user type is acquired and stored at the time of user registration.

In OP102, the control unit 31 determines whether the purpose of use is business activity or not. In the case where the purpose of use is business activity (OP102: YES), the process proceeds to OP104. In the case where the purpose of use is not business activity, or in other words, in the case where the purpose of use is personal use (OP102: NO), the process proceeds to OP103. In OP103, the control unit 31 sets the settable period for the rental period to within a predetermined period of time. Additionally, even in a case where the settable period for the rental period is not limited to within a predetermined period of time, a period of time that is longer than the predetermined period of time is set by default as the settable period for the rental period. For example, the settable period for the rental period is, by default, until one month later.

In OP104, the control unit 31 determines whether return to the departure spot is selected or not. In the case where return to the departure spot is selected (OP104: YES), the process proceeds to OP105. In the case where return to the departure spot is not selected, or in other words, in the case where one-way rental is selected (OP104: NO), the process proceeds to OP106. In OP105, the control unit 31 automatically inputs same information as the departure spot in the section for setting the return spot.

In OP106, the control unit 31 determines whether a rental request is input by a user or not. In the case where a rental request is input by a user (OP106: YES), the process proceeds to OP107. In the case where a rental request is not input by a user (OP106: NO), the control unit 31 stays in a standby state.

In OP107, the control unit 31 determines whether all the required items are input or not. In the case where the rental request screen is the one illustrated in FIG. 7, for example, the required items are the purpose of use (only employees), the departure date/time, the end date/time, the departure spot, and the return spot (only in the case where one-way rental is selected). In the case where all the required items are input (OP107: YES), the process proceeds to OP109. In the case where there is a required item that is not input (OP107: NO), the process proceeds to OP108.

In OP108, the control unit 31 outputs a message requesting input of the required item. Then, the process proceeds to OP106. In OP109, the control unit 31 transmits, to the center server 1, the rental request for the company vehicle, the user identification information, and the search conditions. Then, the process illustrated in FIG. 8 is ended. Additionally, the search condition input process by the user terminal 3 is not limited to the process illustrated in FIG. 8.

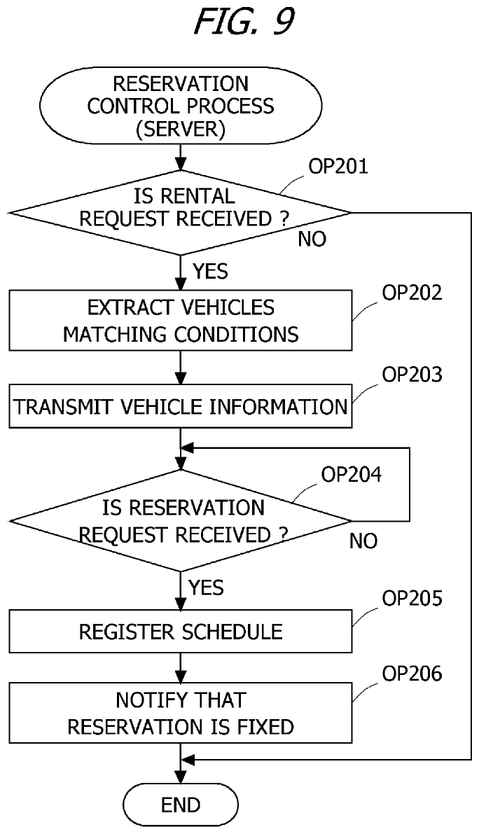

FIG. 9 is an example of a flowchart of a reservation control process by the center server 1. The reservation control process is a process of receiving a rental request for the company vehicle 2, and of registering a schedule for the rental. The process illustrated in FIG. 9 is repeatedly performed during operation of the center server 1. The performer of the process illustrated in FIG. 9 is the CPU 101 of the center server 1, but a functional element is described to be the performer for the sake of convenience. The same applies to flowcharts of subsequent processes by the center server 1.

In OP201, the control unit 11 determines whether a rental request for the company vehicle is received from the user terminal 3 or not. In the case where a rental request for the company vehicle is received from the user terminal 3 (OP201: YES), the process proceeds to OP202. In the case where a rental request for the company vehicle is not received from the user terminal 3 (OP201: NO), the process illustrated in FIG. 9 is ended.

In OP202, the control unit 11 extracts one or more company vehicles 2 that match the search conditions received together with the rental request. The one or more company vehicles 2 that match the search conditions are extracted by referring to the vehicle information DB 13 and the schedule information DB 15, for example. The one or more company vehicles 2 that match the search conditions are one or more vehicles for which a schedule is not set in the rental period included in the search conditions and that are located at the departure spot included in the search conditions at a time of start of the rental period included in the search conditions, for example.

In OP203, the control unit 11 transmits, to the user terminal 3, one or more pieces of information about the one or more company vehicles 2 extracted in OP202. For example, one piece of information about the company vehicle 2 is the identification information of the company vehicle 2, the body type of the vehicle, and the like. Furthermore, one piece of information about the company vehicle 2 may include information about a rental fee.

In OP204, the control unit 11 determines whether a reservation request is received from the user terminal 3 or not. In the case where a reservation request is received from the user terminal 3 (OP204: YES), the process proceeds to OP205. In the case where a reservation request is not received from the user terminal 3 (OP204: NO), the process illustrated in FIG. 9 is ended after a lapse of a predetermined time after a standby state of a predetermined period of time.

In OP205, the control unit 11 creates a schedule for rental of the company vehicle 2 that is the reservation target received together with the reservation request, and registers the schedule in the schedule information DB 15. Furthermore, the vehicle information DB 13 is updated in relation to the company vehicle 2 that is the reservation target.

In OP206, the control unit 11 transmits, to the user terminal 3, a notification indicating that the reservation is fixed. Then, the process illustrated in FIG. 9 is ended. Additionally, in the case where the reservation is not fixed due to some kind of problem, the control unit 11 transmits, to the user terminal 3, a notification indicating that the reservation failed to be fixed.

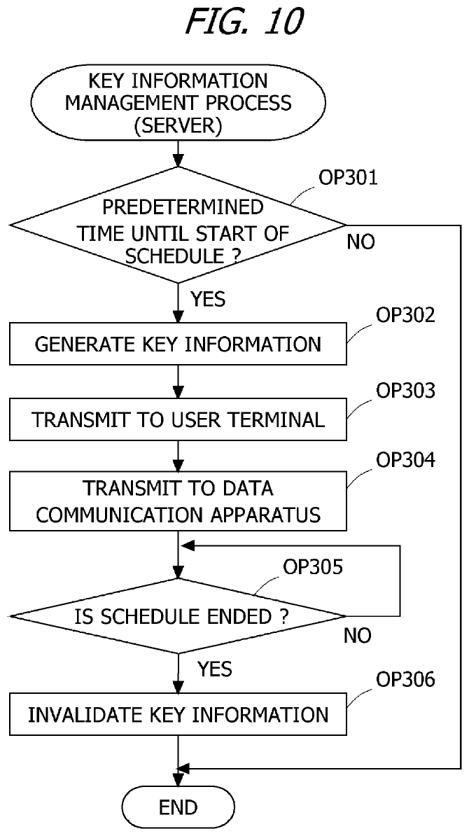

FIG. 10 is an example of a flowchart of a key information management process by the center server 1. The process illustrated in FIG. 10 is repeatedly performed in a case where there is a schedule in the schedule information DB 15 that is not yet carried out.

In OP301, the control unit 11 determines whether a time that is a predetermined time before a scheduled start time of the schedule is reach or not. The predetermined time is one hour before, 30 minutes before or 5 minutes before, for example. In the case where the time that is the predetermined time before the scheduled start time of the schedule is reached (OP301: YES), the process proceeds to OP302. In the case where the time that is the predetermined time before the scheduled start time of the schedule is not yet reached (OP301: NO), the process illustrated in FIG. 10 is ended.

In OP302, the control unit 11 requests the key information generation unit 12 to generate the key information, and acquires the key information for the target schedule. In OP303, the control unit 11 transmits the key information to the user terminal 3 of the user registered for the target schedule. In OP304, the control unit 11 transmits the key information to the data communication apparatus 23 of the company vehicle 2 registered for the target schedule. The data communication apparatus 23 of the company vehicle 2 outputs the received key information to the key unit 21, and the key unit 21 updates the key information.

In OP305, the control unit 11 determines whether the target schedule is ended or not. End of the schedule is detected when a scheduled end time is reached and/or when a notification indicating end of rental is received from the user terminal 3, for example. In the case where the target schedule is ended (OP305: YES), the process proceeds to OP306. The control unit 11 stays in the standby state until the target schedule is ended (OP305: NO).

In OP306, the control unit 11 performs the process of invalidating the key information for the target schedule. Then, the process illustrated in FIG. 10 is ended. Additionally, the processes by the center server 1 that are illustrated in FIGS. 9 and 10 are not limited to the processes illustrated in FIGS. 9 and 10.

<Operations and Effects of First Embodiment>

In the first embodiment, the utilization rate of the company vehicle 2 may be increased by renting out the company vehicle 2 to general users for uses other than business activity. Furthermore, by collecting a rental fee for uses other than business activity, a maintenance fee and the like of the company vehicle 2 may be acquired.

Furthermore, in the first embodiment, rental of the company vehicle 2 to a general user and for personal use is limited to a predetermined period of time. That is, use for business activity is prioritized to use for other than business activity. Accordingly, business activity may be prevented from being obstructed by rental of the company vehicle 2 for uses other than business activity.

Moreover, in the first embodiment, locking, unlocking and engine start of the company vehicle 2 are controlled by transmission/reception of the key information between the key unit 21 of the company vehicle 2 and the user terminal 3 by near-field wireless communication. The center server 1 is able to manage use of the company vehicle 2 by a user by managing the key information, and key management is facilitated.

<Example of Utilization of First Embodiment>

For example, the company-vehicle rental system 100 may be used in the following manner. For example, an automotive dealer may rent out a test-driving vehicle as a rental vehicle when the vehicle is not being used for test-driving. For example, a company, such as a hotel, that owns a minibus for picking up and dropping off guests may rent out the minibus to another company for use of picking up and dropping off workers working after hours.

### Other Embodiments

The embodiment described above is an example, and the present disclosure may be changed and carried out as appropriate without departing from the gist of the present disclosure.

In the first embodiment, a description is given assuming that the company-vehicle rental system 100 is a system that performs management for one company, but the company-vehicle rental system 100 may be shared by a plurality of organizations. This is enabled by preparing the vehicle information DB 13, the user information DB 14, and the schedule information DB 15 for each organization, for example.

Furthermore, the rental fee for use of the company vehicle 2 for other than business activity may be made different between an employee and a general user. For example, in the case where an employee uses the company vehicle 2 for other than business activity, the rental fee may be made cheaper than for a general user by a predetermined percentage.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a controller configured to:
receive, from a terminal of a first user among a plurality of users including a user not belonging to a predetermined organization, a request for use of a first vehicle associated with the predetermined organization for other than a business activity in the predetermined organization, and
register, in response to the request, a schedule for use of the first vehicle for other than the business activity.

2. The information processing apparatus according to claim 1, wherein the controller is further configured to transmit, to the terminal of the first user, key information that is used for unlocking and starting of the first vehicle.

3. The information processing apparatus according to claim 2, wherein the controller is further configured to invalidate the key information in a case where the schedule for use of the first vehicle for other than the business activity is ended.

4. The information processing apparatus according to claim 1, wherein the controller is configured to receive, together with the request, condition information about a departure spot, a return spot and a rental period desired by the first user.

5. The information processing apparatus according to claim 4, wherein a settable period for the rental period is limited to within a first period that is shorter than a settable period for use for the business activity.

6. The information processing apparatus according to claim 4, wherein at least one of the departure spot and the return spot is a location that is associated with the predetermined organization.

7. The information processing apparatus according to claim 4, wherein the departure spot and the return spot are different spots.

8. The information processing apparatus according to claim 4, wherein the departure spot and the return spot are a same spot.

9. An information processing method comprising:
receiving, from a terminal of a first user among a plurality of users including a user not belonging to a predetermined organization, a request for use of a first vehicle associated with the predetermined organization for other than a business activity in the predetermined organization, and
registering, in response to the request, a schedule for use of the first vehicle for other than the business activity.

10. The information processing method according to claim 9, further comprising transmitting, to the terminal of the first user, key information that is used for unlocking and starting of the first vehicle.

11. The information processing method according to claim 10, further comprising invalidating the key information in a case where the schedule for use of the first vehicle for other than the business activity is ended.

12. The information processing method according to claim 9, wherein condition information about a departure spot, a return spot and a rental period desired by the first user is received together with the request.

13. The information processing method according to claim 12, wherein a settable period for the rental period is limited to within a first period that is shorter than a settable period for use for the business activity.

14. The information processing method according to claim 12, wherein at least one of the departure spot and the return spot is a location that is associated with the predetermined organization.

15. The information processing method according to claim 12, wherein the departure spot and the return spot are different spots.

16. The information processing method according to claim 12, wherein the departure spot and the return spot are a same spot.

17. A non-transitory computer-readable recording medium recorded with a program for causing a computer to:
transmit, to a predetermined apparatus, a request for use of a first vehicle associated with a predetermined organization for other than a business activity in the predetermined organization from a first user among a plurality of users including a user not belonging to the predetermined organization, and
receive, from the predetermined apparatus, in response to the request, a schedule for use of the first vehicle for other than the business activity.

18. The non-transitory computer-readable recording medium according to claim 17, wherein the program is further configured to cause the computer to transmit key information that is received from the predetermined apparatus to the first vehicle by predetermined near-field wireless communication, the key information being used for unlocking and starting of the first vehicle.

19. The non-transitory computer-readable recording medium according to claim 17, wherein the program is further configured to cause the computer to transmit, together with the request, condition information about a departure spot, a return spot and a rental period desired by the first user.

20. The non-transitory computer-readable recording medium according to claim 19, a settable period for the rental period is limited to within a first period that is shorter than a settable period for use for the business activity.
